(19) United States
(12) Patent Application Publication
(10) Pub. No.: US 2014/0360087 A1
(43) Pub. Date: Dec. 11, 2014

(54) FISHING LURE

(71) Applicants: Bradley Klose, Dalton, MA (US); Nancy Klose, Dalton, MA (US)

(72) Inventors: Bradley Klose, Dalton, MA (US); Nancy Klose, Dalton, MA (US)

(21) Appl. No.: 14/298,259

(22) Filed: Jun. 6, 2014

Related U.S. Application Data
(60) Provisional application No. 61/831,841, filed on Jun. 6, 2013.

(51) Int. Cl. A01K 85/02; A01K 85/16

(52) U.S. Cl. CPC A01K 85/02; A01K 85/16
USPC 43/42.26

(57) ABSTRACT

A fishing lure has at least one hook having a shank with opposite ends. A bend is at one end of the shank and a barb is at the end of the bend opposite the shank. A body formed from a flexible material surrounds at least parts of the hook. One end of the body is in proximity to the bend of the hook. An outer surface of the body has a plurality of helically generated fins extending at least partly between the first and second ends of the body with channels being defined between the fins. The bend and the barb of the hook are inward of portions of the outer surface of the body defined by at least one of the fins.

This application claims priority on U.S. Provisional Application No. 61/831,841 filed on Jun. 6, 2013.

### BACKGROUND OF THE INVENTION

1. Field of the Invention

The invention relates to fishing lures, and particularly fishing lures that are not likely to be entangled with weeds.

2. Description of the Related Art

A fishing lure includes one or more hooks, an eye for attaching the hooks to a fishing line and a body that is intended to attract a fish and resemble a food source for at least one species of fish. The hooks often are disposed in clusters so that each hook of a cluster extends out in a plane that is aligned radially to from a central axis. The eye for attaching the fishing line generally is at the end of a shank of the fishing lure opposite the bend and barb of the hook. The eye can take many forms, including a closed loop, a releasable clasp and a swivel that permits spinning of the fishing lure about the central axis of the lure or the fishing line. The body of the fishing lure often is configured to resemble a small fish on which the target fish is known to feed. In other instances, the body of the fishing lure is configured to generate a visual stimulus that will attract the target fish. The body of the fishing lure also may be configured to generate movement of the fishing lure as the fishing lure is being pulled through the water. For example, the body of the fishing lure may be configured to permit rotation of the fishing lure about the longitudinal axis or to permit repeated side to side movements as the fishing lure moves through the water.

All bodies of water include plant life to accommodate the symbiotic exchange of oxygen and carbon dioxide with the fish. Some fish are known to congregate in or near weeds and use the weeds for defensive purposes or for seeking other fish as food sources in the weeds. However, the hooks of most known fishing lures snare weeds. Even a short movement of a fishing lure through a bed of weeds will result in a large mass of weeds engaging the hooks and being drawn with the fishing lure as the lure is being reeled back to the fisherman. The engagement of weeds on a fishing lure is problematic in several respects. First, a fishing lure that carries a mass of weeds will no longer resemble the bait fish and will no longer move in the manner that was intended by the designer of the fishing lure. In particular, a large mass of weeds and hook on a fishing lure is likely to prevent a fishing lure from swiveling about the axis of the lure and the line. In some instances, the target fish will strike at the moving mass defined by the small fishing lure and the weeds ensnared on the hooks. However, there is a significant possibility that the target fish will bite at the weeds and not the hook.

Attempts have been made to provide fishing lures that minimize the potential for entanglement between the hooks and weeds. However, these prior attempts are not perceived as being very effective.

Accordingly, it is an object of the invention to provide a fishing lure that prevents the hooks of the fishing lure from being ensnared with weeds as the fishing lure is being pulled through the water.

### SUMMARY OF THE INVENTION

The invention relates to a fishing lure that includes at least one hook. At least one eye is part of or attached to the hook and is configured for engagement with a fishing line. The fishing lure further includes a body at least partly between the eyelet and the hook. The body is formed from an elastomeric material that is very soft and flexible.

The body of the fishing lure includes opposite front and rear ends. The eye that is part of or attached to the hook preferably projects at least partly from the front end of the body so that the front end of the body defines the end of the fishing lure that will be attached to the fishing line. The barb of the fish hook preferably is at or near the rear end of the body. The body of the fishing lure may define a cavity at least in proximity to the rear end of the body and at least part of the fish hook may be disposed in the cavity. In certain embodiments, the entire fish hook may be disposed with in the cavity at the rear end of the body. In other embodiments, however, the barb may be disposed externally of the cavity and may lie substantially adjacent the external surface of the body at a position near the rear end of the body. The external surface of the body may be configured to generate a specified movement of the fishing lure as the fishing lure is being pulled through the water. For example, the external surface of the body may be formed to include a generally helical array of flutes or channels. The helical array of flutes or channels will interact with the water as the fishing lure is being pulled through the water and will generate a spinning movement of the fishing lure as the fishing lure is pulled through the water. Other external surface configurations may be provided to achieve other desired movements of the fishing lure.

The fishing lure may further include one or more extensions rearward of the body in an effort to provide an enhanced visual stimulation as the fishing lure is being pulled through the water. For example, a plurality of filaments may be incorporated into the fishing lure. Each filament may have an end mounted in the cavity of the body of the fishing lure and may have extensions that project rearward of the body of the fishing lure. The filaments may have colors or reflective characteristics that will provide an appropriate visual stimulus to a target fish.

In the preferred embodiment, the shank of the fishing hook will be disposed interiorly of the body of the fishing lure, and preferably within the cavity at the rear end of the fishing lure. The bend between the shank of the fishing hook and the barb preferably is adjacent the rear end of the body in the preferred embodiment. Additionally, the preferred embodiment of the fishing lure provides the barb of the hook external of and adjacent to the outer surface of the body and preferably with in a channel formed on the exterior of the body. This disposition of the barb of the hook will substantially prevent the hook from engaging weeds. However, the soft flexible nature of the body will cause the body to collapse and deform when struck by a fish. Hence, the jaws of the fish will move sufficiently inward relative to the hook to permit the barb of the hook to engage the fish securely. In an alternate embodiment, the entire hook, including the barb and the point, will be disposed within the cavity at the rear end of the body. This design relies upon the ability of the barb to pierce through the soft resilient rubber material of the body when the body is struck by a fish.

The at least one hook preferably comprises an array of hooks, and preferably three hooks that are arrayed equiangularly about the axis of the fishing lure. Thus, the bends and barbs of the hooks will be separated from one another by approximately 120°. In this embodiment, the barbs and points of all three hooks will lie substantially adjacent the external surface of the body and preferably within helical channels that extend along the external surface of the body.

### BRIEF DESCRIPTION OF THE DRAWINGS

FIG. 1 is a perspective view of a fishing lure in accordance with an embodiment of the invention.

FIG. 2 is a front end elevation of the fishing lure.

FIG. 3 is a rear end elevation of view of the fishing lure

FIG. 4 is a side elevational view of the fishing lure.

FIG. 5 is a cross-sectional view taken along line 5-5 of FIG. 3.

### DETAILED DESCRIPTION

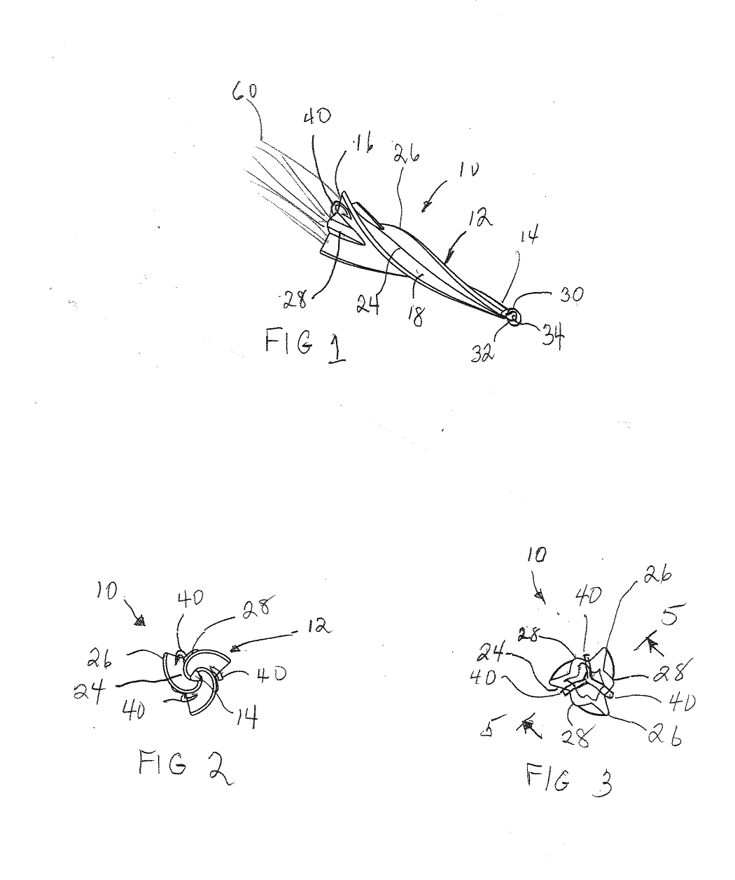

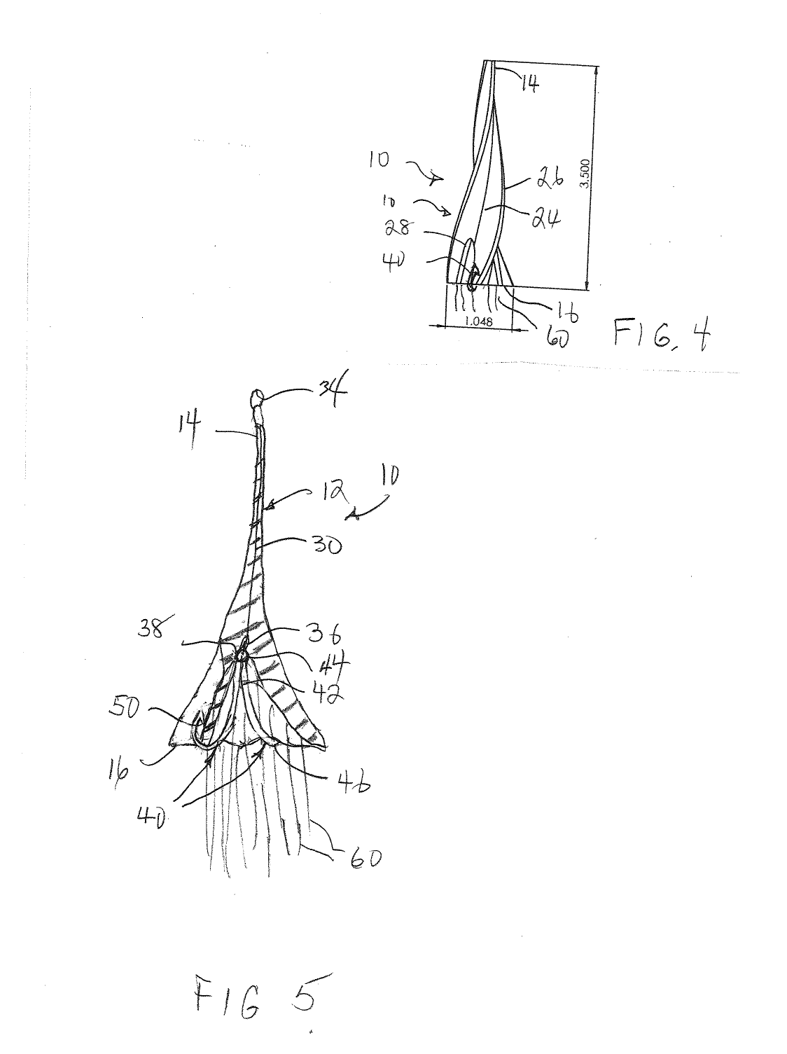

A fishing lure in accordance with the invention is identified generally by the numeral 10 in FIGS. 1-5. The fishing lure 10 includes a body 12 with opposite front and rear ends 14 and 16, and outer surface 18 extending between the front and rear ends 14 and 16. A cavity 20 extends into the body 12 at the rear end 16 and has an inner surface 22. The body 12 tapers from a small cross-sectional dimension adjacent the front end 14 to a maximum cross-sectional dimension adjacent the rear end 16. The size of the body 12 will vary in accordance with the species of fish for which the lure 10 is used. In a typical embodiment intended for freshwater fishing, the body will have a length of about 3.5 inches and a width at the rear end 16 of about 1 inch. The body 12 is formed from an elastic material that is soft and flexible. More particularly, the dimensions of the body 12 and the material from which the body 12 is formed are selected so that if the front end of the body is gripped with the front and 14 pointing down, the rear end 16 of the body 12 will deflect into a substantially inverted U-shape due to the weight of the rear parts of the body. The softness and flexibility of the material from which the body is formed is intended to enable the body to yield significantly in response to the forces exerted by a fish biting on the body 12 adjacent the rear end 16 and outward of the cavity 20.

The outer surface 18 of the body 12 preferably is formed with a plurality of substantially helically generated flutes or channels 24 that are separated from one another by a corresponding plurality of substantially helically generated large and small fins 26 and 28. More particularly, the large fins 26 extend substantially helically from the rear end 16 of the body 12 substantially entirely to the front end 14 thereof. The small fins 28, however, extend less than one half the length of the body 12 from the rear end 16 toward the front end 14 thereof. Thus, the channels 24 on opposite sides of the small fins 28 merge with one another at positions between the small fins 28 and the front end 14 of the body 12. The small fins 28 also project slightly smaller radial distances than the large fins 26.

The fishing lure 10 further includes a leader 30 that extends from a location external of the front end 14 of the body 12 to a location within body 12 and possibly within the cavity 20. The leader has a front end 32 and a front loop 34 is defined at the front end 32. The front loop 34 is configured to be engaged by a fishing line or a fixture mounted to the end of a fishing line. The leader 30 also has a rear end 36 and a rear loop 38, both of which are disposed in or near the cavity 20 that opens into the rear end 16 of the body 12. The leader 30 may be threaded or otherwise urged through front parts of the body 12 and at least the front loop 34 may be formed after the end of the leader 30 emerges from the body 12. Alternatively, the body 12 can be molded around the leader 30 as explained below.

The fishing lure 10 further includes three hooks 40. Each hook 40 includes a shank 42, and eye 44 at one end of the shank 42 and a bend 46 at the end of the shank 42 opposite the eye 44. A barb 50 is formed at the end of the bend 46 opposite the shank 42 and a point 52 is formed at the free end of the barb 50. The eye 44 on each hook 40 is connected to the rear loop 38 of the leader 30. The shank 42 of each hook 40 is disposed in or near the cavity 20 that opens into the rear end 18 of the body 12. The barb 50 of each hook 40 in the illustrated embodiment is external of the body 12 and adjacent the outer surface 18 of the body 12 within one of the channels 24. The inner concave surface of the bend 46 of each hook 40 substantially abuts the rear end 16 of the body 12. The three hooks 40 may define part of a hook cluster with a single shank 46 and a single eye 44 connected to the rear loop 38 of the leader 30. Additionally, the fishing lure 10 may be formed by molding the body 12 around the connected hooks 40 and leader 30. In this regard, the connected hooks 40 and leader 30 may be placed in a mold for forming the body 12. The body 12 then may be formed around the interconnected hooks 40 and leader 30 by an insert molding process.

The illustrated embodiment of the lure 10 further includes a plurality of filaments 60 looped through the rear loop 38 of the leader 30 at a position inside the cavity 20 of the body 12. Free ends of the filaments 60 extend rearward beyond the rear end 16 of the body 12. The filaments 60 may be formed in plural colors and at least selected filaments 60 may be multicolored or formed with iridescent flakes that will reflect ambient light.

The fishing lure 10 is used by connecting the fishing line to the front loop 34 of the leader 30. The fishing lure 10 then is cast in the conventional manner. The front end 14 of the body 12 will advance through the water as in the lure 10 is being reeled in. The helical channels 24 in the outer surface 18 of the body 12 will cause the entire lure 10 to spin about the longitudinal axis. The points 52 and the barbs 50 of the hooks 40 are external of the body 12, but lie adjacent to the outer surface 18 at positions near the rear and 16 of the body. Additionally, the points 52 and the barbs 50 lie within the channels 24 and between an adjacent pair of helical fins 26, 28 formed on the outer surface 18 of the body. The fishing lure 10 may advance through weeds in the water as the lure 10 is being reeled in. However, the bends 46, barbs 50 and points 52 of the hooks 40 are not in positions to ensnare the weeds and hence weeds will not be pulled inward with the lure 10. Rather, the weeds will slide over the outer surfaces formed by the helical fins 26, 28 and will not be in a position to become hooked on the bends 46, barbs 50 and points 52. The moving and spinning lure 10 is likely to attract a fish and the fish is likely to bite into at least parts of the body in proximity to the rear end 16. The force of this bite will cause the soft flexible body 12 to compress and deform inward and laterally of the barbs 50 on the hooks 40. As a result, the hooks 40 will perform their intended function of hooking the fish even though the hooks 40 are in position that are not likely to engage weeds.

The invention has been described with respect to certain preferred embodiments. However, various changes can be made without departing from the scope of the invention. For example, the barbs 50 and points 52 of the hooks 40 may be disposed within the cavity 24 adjacent the rear and 16 of the body 12. With this embodiment, the points 52 of the hooks 40 will pierce through the soft flexible material of the body 12 for hooking the fish. Alternatively, some hooks may be provided at the position shown in the illustrations, whereas other hooks may be provided forwardly.

The illustrated embodiment shows arrays of substantially helical channels 24 and substantially helical fins 26, 28 formed on the outer surface of the body. However, other surface configurations may be provided.

A simple front loop 34 is illustrated as projecting beyond the front end 14 of the body 12. However, the fishing lure 10 can have a swivel connection instead of or in addition to the front loop 34.

Filaments 60 are illustrated as extending beyond the rear end of the body 12. However, the filaments can be omitted or can be replaced by other structures that are believed to be appropriate for tracking a particular species of fish.

We claim:

1. A fishing lure, comprising:
at least one hook having a shank with opposite ends, a bend at one end of the shank and a barb at the end of the bend opposite the shank;
a leader connected to the shank and formed with a loop; and
a body formed around at least parts of the hook and the leader, the body having opposite first and second ends, the first end of the body being in proximity to the loop of the leader and the second end of the body being in proximity to the bend of the hook, the body being formed from a flexible elastomeric material and having an outer surface extending between the first and second ends of the body, the outer surface having a plurality of helically generated fins extending at least partly between the first and second ends of the body with channels being defined between the fins, the bend and the barb of the hook being inward of portions of the outer surface of the body defined by at least one of the fins.

2. The fishing lure of claim 1, wherein the barb and at least part of the bend of the hook are disposed in one of the channels defined in the outer surface of the body.

3. The fishing lure of claim 2 wherein the at least one hook comprises a plurality of hooks, the shanks of the respective hooks being connected to one another and connected to the leader.

4. The fishing lure of claim 3, wherein the plurality of hooks comprise three hooks.

5. The fishing lure of claim 4, wherein the three hooks are separated from one another by approximately 120°.

6. The fishing lure of claim 1, wherein the loop of the leader is external of the body.

7. The fishing lure of claim 1, wherein the leader is configured to permit the fishing lure to spin relative to a fishing line connected to fishing lure.

8. The fishing lure of claim 1, wherein the plurality of helically generated fins include an alternating array of large fins and small fins.

9. The fishing lure of claim 8, wherein the barb of the hook is disposed between one of the large fins and one of the small fins.

10. The fishing lure of claim 1, where in the bend of the hook has a concave side nested with the second end of the body.

11. The fishing lure of claim 1, wherein the second end of the body includes a concavity in which the hook is disposed.
